(19) United States
(12) Patent Application Publication
(10) Pub. No.: US 2010/0313187 A1
(43) Pub. Date: Dec. 9, 2010

(54) METHOD AND SYSTEM FOR DETECTING INFEASIBLE PATHS

(76) Inventors: Hee Beng Kuan TAN, Singapore (SG); Hongyu ZHANG, Beijing (CN)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/479,641

(22) Filed: Jun. 5, 2009

(51) Int. Cl. G06F 9/44

(52) U.S. Cl. 717/131; 717/124

(57) ABSTRACT

A method of testing a software program comprises obtaining path properties of an infeasible path, selecting a path from the software program and obtaining path properties of the selected path, wherein the method further comprises comparing path properties of the selected path to the path properties of the infeasible path to identify a target path and determine infeasibility of the target path.

### TECHNICAL FIELD

The present application generally relates to a method for testing a computer software program, and more particularly to a method for detecting infeasible paths in testing a computer software program.

### BACKGROUND

In computer software engineering applications, particularly in software testing and debugging, code coverage is a way to measure the level of testing performed in a software program. While code coverage indicates what remains to be tested, full code coverage becomes a desired, but often infeasible, goal. There are a number of coverage criteria in an application. A typical software development measures coverage in terms of either the number of statements or the number of branches to be tested. Statement coverage may indicate an execution of each line of the source code. Branch coverage may measure if every Boolean expression in each condition structure (such as an IF statement) is evaluated. However, even with full statement and branch coverage, critical bugs may still be present in code logic because statement and branch coverage fail to indicate if the logic of the codes is executed. Accordingly, path coverage is a comprehensive technique to ensure adequate testing because the term implies an execution of every possible route through a given part of the code.

In practice, however, full path coverage may be impractical or impossible to achieve because a program with a succession of n decisions may have up to 2ⁿ possible paths and loop constructs and therefore may result in an infinite number of paths. Within those infinite paths, a great number of paths may be infeasible in that there is no input to the program under test that can cause a particular path to be executed or a path may not be possible to execute for any input data. Accordingly, no test data or test cases need to be generated for such paths. However, during testing, it may not be possible to avoid an attempt to generate data for such infeasible paths. Therefore, there have been various proposals to efficiently identify infeasible paths to ensure adequate testing without exponentially increasing the number of tests required.

The most common methods are performed by adapting data flow analysis or constraint propagation analysis method. One technique used to detect infeasible paths is to execute symbolic evaluation of each program path. By applying symbolic evaluations, each program path may be executed using symbolic values rather than actual values of input variables. However, using symbolic evaluation to verify infeasibility of individual program paths with all possible inputs is time-consuming and the results may be unreliable. Moreover, the complexity of verification will be gradually built up when infeasible paths are encountered.

### BRIEF SUMMARY

According to one exemplary embodiment of the invention, a method of testing a computer software program comprises obtaining path properties of an infeasible path, selecting a path from the software program and obtaining path properties of the selected path. The method further comprises comparing path properties of the selected path to the path properties of the infeasible path to identify a target path and determining infeasibility of the target path.

According to another exemplary embodiment of the invention, a computer-readable storage medium comprises a plurality of computer readable program code portions. The computer-readable program code portions comprise a first executable portion configured to select a path in a software program. A general program analysis is performed over the selected path and properties of the selected path and properties of an infeasible path are compared to identify a target path.

According to another exemplary embodiment of the invention, a system of testing a software program comprises a comparison unit. The comparison unit is configured to select a path in a software program, execute a general program analysis over the selected path and compare properties of the selected path to properties of an infeasible path to identify a target path.

### BRIEF DESCRIPTION OF THE DRAWINGS

The foregoing summary, as well as the following detailed description of the invention, will be better understood when read in conjunction with the appended drawings. The embodiments illustrated in the figures of the accompanying drawings herein are by way of example and not by way of limitation. In the drawings:

FIG. 1 illustrates a flow chart of detecting infeasible paths according to one exemplary embodiment of the present invention;

FIG. 2 shows an exemplary flow control graph for a particular function to illustrate infeasible paths according to one exemplary embodiment of the present invention;

FIG. 3 shows another exemplary flow control graph for a particular function to illustrate infeasible paths according to one exemplary embodiment of the present invention; and

FIG. 4 shows a block diagram of an exemplary system to execute the flow chart illustrated in FIG. 1 according to the present invention.

### DETAILED DESCRIPTION

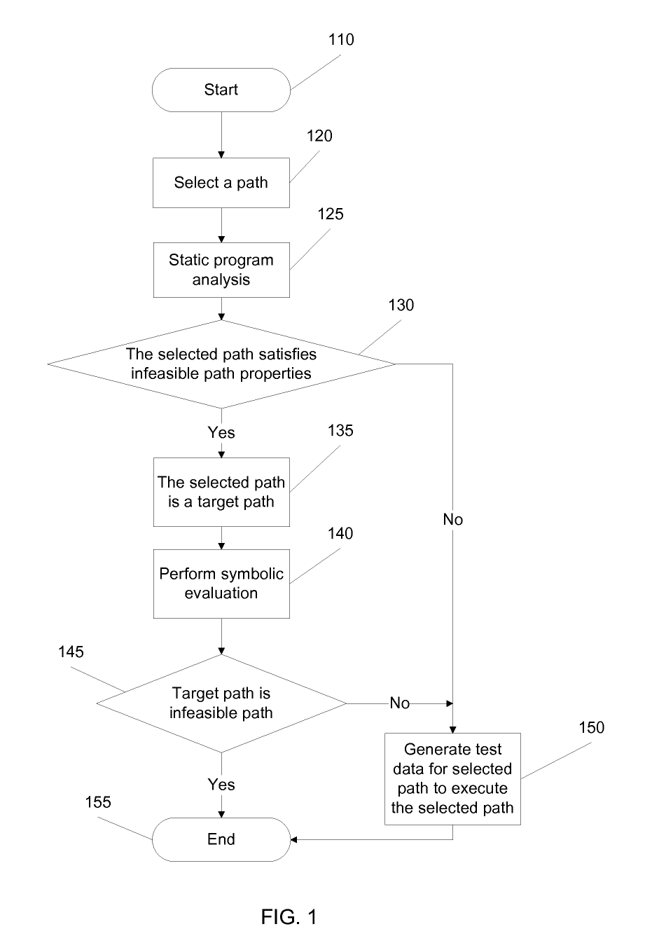

FIG. 1 is a flow chart illustrating various steps in detecting infeasible paths according to one exemplary embodiment of the present invention. Referring to FIG. 1, the detecting method starts at step 110 and continues at step 120 to select a path from the software program. To identify an infeasible path, it is desirable to obtain infeasible path properties before execution of the software program.

Path properties may be derived based on analysis of the behavior of the program. The behavior of a program may be defined as the trace of all input/output events it performs and may determine how the program responds for given inputs. Path properties may include loop bounds, function call entries and exits, branch conditions, or other information known to one skilled in the art. Analysis of the derived path properties indicates that most infeasible paths, caused by limited source code patterns, may exhibit some common path properties, such as flag-based inhibitor property or a pair of shallow conflicting branches. Therefore, through obtaining general infeasible path properties, it becomes possible to detect most of the infeasible paths prior to execution of symbolic evaluation. The complexity of the verification by the symbolic evaluation is thus reduced.

An example is illustrated by a simple function. Following is the source code of an exemplary function PathDect1:

| | |
|---|---|
| | Public PathDect1 (int I) |
| | { |
| /*1*/ | int J = 0; |
| /*2*/ | if (I > 5) |
| /*3*/ | J = 4; |
| /*4*/ | if (I + J < 8) |
| /*5*/ | print (“error”); |
| | } |

PathDect1 has one external variable, input I. An assignment statement initializes an internal variable J as 0. The IF statement provides a way to execute one set of instructions when a stated condition (e.g., I>5) in the IF statement is true.

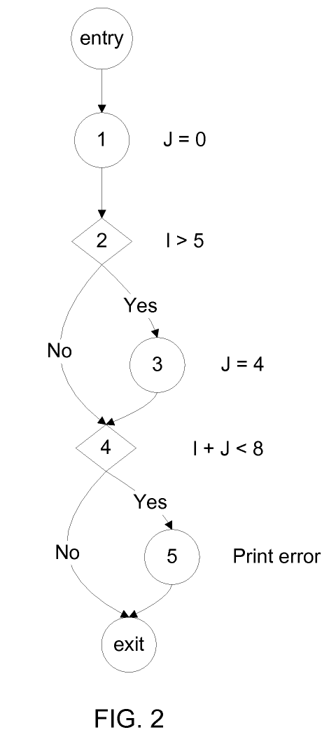

FIG. 2 is a control flow graph corresponding to the function PathDect1. FIG. 2 shows five nodes numbered 1 through 5. Each node indicates a statement in the function PathDect1. There are two decision nodes (e.g., nodes 2 and 4). Each of them implies a condition stated in the IF statement in the function. For example, the decision node 2 indicates the condition (I>5). In this example, there are a plurality of paths (e.g., entry-1-2-3-4-5-exit, entry-1-2-3-4-exit and entry-1-2-4-exit) associated with these five nodes.

In the illustrated PathDect1 function, condition in a first IF statement (I>5) at node 2 refers to the external variable I. Condition in a second IF statement (I+J<8) at node 4 refers to the external variable I and the internal variable J. For convenience and brevity, nodes that indicate conditions referring to the same external variable(s) are defined as correlated nodes. In this example, because condition statements at nodes 2 and 4 refer to the same external variable I, nodes 2 and 4 are correlated nodes. By analyzing the properties of software program, a path which passes through both correlated nodes may be an infeasible path. For convenience and brevity, a path that contains both correlated nodes is defined as correlated path. In this example, since paths (entry-1-2-3-4-5-exit), (entry-1-2-4-5-exit) and (entry-1-2-3-4-exit) all contain correlated nodes 2 and 4, any one of these correlated paths may satisfy properties for infeasible paths.

To determine if a path have infeasible path properties, a general program analysis is then performed over the selected path at step 125. The general program analysis may be a static program analysis that aims at analyzing if the selected path shares infeasible path properties. If the selected path shares one or more infeasible path properties, i.e., a “YES” result is obtained at step 130, the selected path is identified as a target path at step 135 and a symbolic evaluation will be executed at step 140. In this embodiment, one of the correlated paths, for example, path (entry-1-2-3-4-5-exit), may be selected at step 120. Then a static program analysis will be performed at step 125 to check if the selected correlated path satisfies the infeasible path properties at step 130. If a “YES” is obtained at step 130, the selected correlated path will be identified as a target path at step 135. The target path may or may not be an infeasible path, the determination of which is further examined by an advanced analysis at step 140. In this embodiment, the advanced analysis may be a symbolic evaluation analysis used to detect the infeasibility of the target path. Symbolic execution is a way to analyze the behavior of a program for all possible inputs. In other words, all possible inputs may be executed on one program path from entry node to exit node, e.g., from entry node to exit node on path (entry-1-2-3-4-5-exit) as illustrated in FIG. 2. Symbolic evaluation proceeds like a normal execution except that the input values computed may be symbolic values. In executing the symbolic evaluation, a path would be defined as an infeasible path if a path is not possible to be executed for any input data or no actual input exists that would cause this particular path to be taken.

After symbolic evaluation is applied to the target paths at step 140, path (entry-1-2-3-4-5-exit) in this example is evaluated to be an infeasible path at step 145. For convenience, a correlated path which has been evaluated and determined as an infeasible path is defined to share a pair of shallow conflicting infeasible path properties. In this embodiment, referring to the function PathDect1 and FIG. 2 again, node 2 is a decision node as mentioned above and branch 2-3 predicates I>5 in the first IF statement in the function PathDect1. When I>5, J is assigned as 4. In such an instance, I+J cannot be less than 8. As a result, branch 4-5 cannot be reached because the constraint I+J<8 can not be satisfied. Therefore, the path (entry-1-2-3-4-5-exit) is an infeasible path and cannot be executed. The infeasible path (entry-1-2-3-4-5-exit) would be eliminated from consideration for subsequent testing. That is, test cases to generate input data on the path (entry-1-2-3-4-5-exit) under the above path conditions may be avoided, thereby reducing the overall cost of testing. Then the method proceeds to step 155 to terminate the detection.

On the other hand, the constraint I<5 can always be satisfied thus the branch 2-4 can be reached. As a result, path (entry-1-2-4-exit) is not an infeasible path, and therefore the detection method moves to step 150 to run a set of test cases. Test data using actual values of input variables will be generated to execute this target path from the entry node to the exit node.

In some instances, a selected path may exhibit properties which are mutually exclusive of the infeasible path properties. That is, a “NO” result is determined at step 130. Then it can be decided that the selected path is not an infeasible path. No symbolic evaluation will be applied to the selected path to evaluate its feasibility. Test data will be generated to conduct test cases on the selected path at step 150 as shown in FIG. 1.

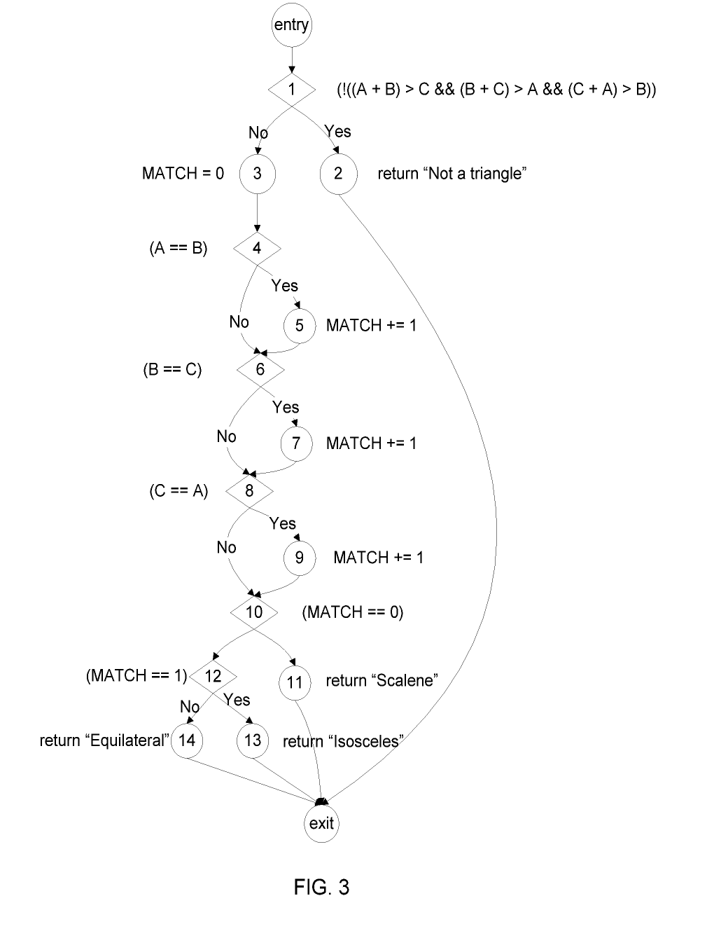

Depending on various code patterns, there may be various infeasible paths properties. Another exemplary embodiment is illustrated by following function. A corresponding control flow graph is illustrated in FIG. 3.

| | |
|---|---|
| | Public PathDect2 (int A, int B, int C) |
| | { |
| /*1*/ | if(!((A + B) > C && (B + C) > A && (C + A) > B)) |
| /*2*/ | return “Not a triangle”; |
| /*3*/ | int MATCH = 0; |
| /*4*/ | if (A == B) |
| /*5*/ | MATCH += 1; |
| /*6*/ | if (B == C) |
| /*7*/ | MATCH += 1; |
| /*8*/ | if (C == A) |
| /*9*/ | MATCH += 1; |
| /*10*/ | if (MATCH == 0) |
| /*11*/ | return “Scalene”; |
| /*12*/ | else if (MATCH == 1) |
| /*13*/ | return “Isosceles”; |
| | else |
| /*14*/ | return “Equilateral”; |
| | } |

In PathDect2 function, there are three external variables, inputs A, B and C, and one internal variable MATCH. MATCH is initialized as 0 at node 3. In various examples, MATCH may be of an integer, a real number, a string, a Boolean expression, or other basic data type known to one skilled in the art. For convenience and brevity, an internal variable that is defined as a basic data type in the function is named as a flag. In this example, the internal integer variable MATCH is a flag. Because decision nodes 10 and 12 both merely refer to the flag “MATCH”, decision nodes 10 and 12 are flag nodes. A path containing either flag node 10 or flag node 12 may be an infeasible path. For convenience and brevity, a path containing a flag node is defined as a flag path. In this embodiment, a flag path (entry-1-3-4-5-6-8-10-11-exit) may be selected at step 120. A static program analysis is then applied to the selected flag path at step 125 to perform a comparison to compare the properties of the selected flag path to the infeasible path properties at step 130. After the comparison, if the properties of the selected flag path satisfy the infeasible path properties, the selected flag path will be identified as a target path at step 135 and will be evaluated for infeasibility by performing symbolic evaluation at step 140. In this embodiment, the target path may be one of these paths: (entry-1-3-4-5-6-8-10-11-exit), (entry-1-3-4-5-6-8-10-12-13-exit), (entry-1-3-4-6-8-9-10-12-14-exit). After the application of symbolic evaluation, path (entry-1-3-4-5-6-8-10-11-exit) is determined as an infeasible path. For convenience, the flag path which has been evaluated and determined as an infeasible path is defined to share flag-based inhibitor infeasible path property.

On the other hand, paths that do not pass through both nodes 10 and 12 may not share the infeasible path properties, such as path (entry-1-2-exit). Therefore, symbolic evaluation may not be executed on those paths to evaluate the infeasibility. Test cases will be conducted on them.

The terms such as “correlated nodes”, “correlated path”, “flag”, “flag path”, “pair of shallow conflicting infeasible path properties” and “flag-based inhibitor infeasible path property” have been used herein merely for convenience and brevity to describe the nodes and paths which may be used to determine if a selected path shares infeasible path properties. It is understood, however, that other terms may be used to describe similar nodes, paths and infeasible path properties.

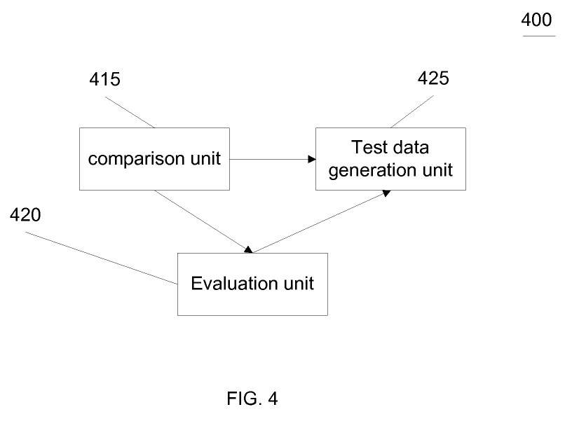

FIG. 4 shows a detection system 400 for performing one embodiment of the present invention. Referring to FIG. 4, the detection system 400 may comprise a comparison unit 415. The comparison unit 415 is configured to select a path and execute static program analysis to check if the selected path shares infeasible path properties. If the selected path shares one or more infeasible path properties, the selected path is identified as a target path and an advanced analysis, e.g., a symbolic evaluation, may be executed by an evaluation unit 420 on the target path to determine infeasibility of the target path. By executing the symbolic evaluation, the infeasibility of the target path may be determined. If the target path is determined not to be an infeasible path by execution of the symbolic evaluation or the selected path does not share any infeasible path properties, a test data generation unit 425 will generate test data on the selected path to execute test cases from the entry node to the exit node of the selected path.

According to one aspect of the present invention, all or portion of the system of the present invention, such as an analyzing unit configured to execute a general program analysis to program paths and a pattern comparison unit configured to compare a selected path to predetermined path patterns of infeasible paths, generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIG. 1 is a flowchart of a method, system and program product according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowchart. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowchart. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowcharts.

Accordingly, blocks or steps of the flowchart support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

It will be appreciated by those skilled in the art that changes could be made to the examples described above without departing from the broad inventive concept. It is understood, therefore, that this invention is not limited to the particular examples disclosed, but it is intended to cover modifications within the spirit and scope of the present invention as defined by the appended claims.

What is claimed is:

1. A method of testing a software program, the method comprising:
obtaining path properties of an infeasible path;
selecting a path from the software program;
obtaining path properties of the selected path;
comparing path properties of the selected path to the path properties of the infeasible path to identify a target path; and
determining infeasibility of the target path.

2. The method of claim 1, wherein path properties of the infeasible path include at least one of flag-based inhibitor property and pair of shallow conflicting properties.

3. The method of claim 1 wherein the step of comparing path properties of the selected path to the path properties of the infeasible path to identify a target path includes a step of executing a general program analysis to the software program.

4. The method of claim 3, wherein the general program analysis comprises static program analysis.

5. The method of claim 1 further comprising generating test data from the selected path to execute test cases.

6. The method of claim 1 further comprising a step of executing an advanced analysis on the target path to determine the infeasibility of the target path.

7. The method of claim 6, wherein the advanced analysis comprises symbolic evaluation.

8. The method of claim 1, wherein path properties are obtained from static analysis of the software program.

9. A computer-readable storage medium comprising a plurality of computer readable program code portions, the computer-readable program code portions comprising:
a first executable portion configured to
select a path in a software program;
perform a general program analysis over the selected path; and
compare properties of the selected path to properties of infeasible path to identify a target path.

10. The computer-readable storage medium of claim 9, wherein the first executable portion is configured to execute a static program analysis to the selected path.

11. The computer-readable storage medium of claim 9, wherein the computer-readable program code portions further comprise a second executable portion configured to generate test data on the selected path to execute test cases.

12. The computer-readable storage medium of claim 11, wherein the computer-readable program code portions further comprise a third executable portion configured to execute an advanced analysis on the target path to determine the infeasibility of the target path.

13. The computer-readable storage medium of claim 12, wherein the third executable portion is configured to execute symbolic evaluation on the target path to determine infeasibility of the target path.

14. A system to test a software program, the system comprising a comparison unit configured to:
select a path in a software program;
execute a general program analysis over the selected path; and
compare properties of the selected path to properties of infeasible path to identify a target path.

15. The system of claim 14, wherein the general program analysis comprises static program analysis.

16. The system of claim 14 further comprising a test data generation unit configured to generate test data on the selected path to execute test cases.

17. The system of claim 14 further comprising an advance analysis unit configured to execute an advanced analysis on the target path to determine infeasibility of the target path.

18. The system of claim 17, wherein the advance analysis comprises symbolic evaluation.
